(19) United States
(12) Patent Application Publication
(10) Pub. No.: US 2026/0310674 A1
(43) Pub. Date: Oct. 8, 2026

(54) MULTI-MODAL INTERACTION FOR PEOPLE WITH DISABILITY

(71) Applicant: Panasonic Well LLC, Palo Alto, CA (US)

(72) Inventor: Ramin Firoozye, San Francisco, CA (US)

(21) Appl. No.: 19/276,805

(22) Filed: Jul. 22, 2025

Related U.S. Application Data
(60) Provisional application No. 63/783,817, filed on Apr. 4, 2025.

(51) Int. Cl. G06F 16/2457

(52) U.S. Cl. CPC G06F 16/24575

(57) ABSTRACT

A multi-modal interface framework that facilitates interacting with applications and system using various modes of interaction is provided. A computer-implemented method can include detecting one or more interactions performed by a user. In some instances, the one or more interactions are performed using a first input mode. The computer-implemented method can also include processing the one or more interactions using an intent-discovery machine-learning model to extract an intent associated with the one or more interactions. The computer-implemented method can also include determining a context based on the intent. The context can identify a previous session of interactions. The computer-implemented method can also include resuming the previous session of interactions in accordance with the context and the intent. In some instances, resuming the previous session of interactions includes using a second input mode to perform subsequent interactions.

### CROSS-REFERENCES TO RELATED APPLICATIONS

The present patent application claims the priority benefit of U.S. Provisional Patent Application 63/783,817 filed Apr. 4, 2025 and is related to U.S. Patent Applications entitled “ABILITY-BASED USER INPUT INTERFACE” (POL Ref. 109304-845007-008900US) filed Jul. 22, 2025 and “SEAMLESS TRANSITION BETWEEN ON-DEVICE, MOBILE, AND CLOUD-BASED AI/ML MODELS” (POL Ref. 109304-845002-009200US) filed Jul. 22, 2025, U.S. Provisional Application 63/783,813 filed Apr. 4, 2025 entitled “ABILITY-BASED USER INPUT INTERFACE” and U.S. Provisional Application 63/783,829 filed Apr. 4, 2025 entitled “SEAMLESS TRANSITION BETWEEN ON-DEVICE, MOBILE, AND CLOUD-BASED AI/ML MODELS”, the disclosures of which are incorporated herein by reference in its entirety for all purposes.

### FIELD

The present disclosure relates generally to providing accessibility features for users with diminished abilities. In one example, the systems and methods described herein may include a multi-modal interface framework that facilitates interacting with applications and system using various modes of interaction without losing context.

### SUMMARY

Disclosed embodiments may provide a multi-modal interface framework that facilitates interacting with applications and system using various modes of interaction without losing context or being forced to remain in a single input mode. A computer-implemented method can include detecting one or more interactions performed by a user. In some instances, the one or more interactions are associated with a particular application, and the one or more interactions are performed using a first input mode. The computer-implemented method can also include processing the one or more interactions using an intent-discovery machine-learning model to extract an intent associated with the one or more interactions. The intent can identify one or more intended inputs for the application and an expected output to be triggered in response to the one or more intended inputs.

The computer-implemented method can also include determining a context based on the intent. The context can identify a previous session of interactions that store previously used input modes, user ability data, and interaction progress associated with the previous session. In some instances, the previous session is associated with the particular application. The computer-implemented method can also include resuming the previous session of interactions in accordance with the context and the intent. In some instances, resuming the previous session of interactions includes using a second input mode to perform subsequent interactions, and the second input mode is different from the first input mode.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates a schematic diagram of implementing multi-modal interaction for people with varying levels of disability, according to some embodiments.

FIG. 2 shows an illustrative example of a process for implementing multi-modal interaction for people with varying levels of disability, in accordance with some embodiments.

FIG. 3 illustrates a schematic diagram for access and storage of user disability data across various geographic locations, according to some embodiments.

FIG. 4 shows an illustrative example of a process for access and storage of user disability data across various geographic locations, in accordance with some embodiments.

FIG. 5 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### I. Techniques for Multi-Modal Interaction for People With Disability

The present techniques allow users to interact smoothly with a system using various modes of interaction without losing context or being forced to remain in a single mode. This flexibility ensures that users can seamlessly switch between different input methods, such as voice commands, touch gestures, keyboard inputs, or assistive technologies, depending on their currently ability levels. By maintaining context across different interaction modes, the system enhances usability and accessibility, making it easier for individuals to complete tasks efficiently without disruption. This approach is particularly beneficial in environments where users may require adaptive interfaces due to situational or physical constraints.

### A. Multi-Modal Interaction With Physical Devices for People With Varying Levels of Disability

Individuals may have different levels of ability to interact with computing systems. In addition, these abilities are likely to change as the individuals age. These include, but are not limited to eyesight, hearing, speaking, touch, motor control, comprehension, and memory. Variations in these capabilities can affect how users interact with a system, necessitating adaptable and multimodal interaction methods. For example, users with limited eyesight may rely on screen readers or high-contrast visuals, while those with reduced motor control may prefer voice commands or adaptive hardware. Similarly, individuals with cognitive or memory-related challenges benefit from simplified navigation and clear, consistent UI elements.

Over time, factors such as declining vision, reduced motor skills, or cognitive changes can impact how a person engages with technology. However, existing systems remain static and fail to accommodate varying interaction abilities. Accordingly, there is a need to design interfaces that adapt to a user's changing capabilities, such that technology can remain inclusive and allow individuals to continue using digital systems without frustration or the need for significant adjustments.

In existing systems, the user is required to operate within the limits of a specific application and interaction model. For example, tapping or scrolling a mobile phone app with fingers. For the visually impaired, a mobile app may allow support for a screen reader, but that may not allow using voice or gestures. Another use-case might be to use voice with a voice assistant like Siri, Google Home, or Alexa. Switching from voice interaction to a different mode is not possible.

However, users are assumed to have a variety of abilities which may wax and wane during the day or as they age. If a user's motor-control starts diminishing, they may no longer be able to tap or scroll the mobile app. If their voice weakens, voice assistants may no longer be an option.

Furthermore, across a sequence of a pages of the application, it is possible to require a user to initiate the event with a first type of input then follow up with another type of input. Stated differently, there is the possibility of a user starting an interaction in one way, then switching to another mode in the middle and continuing as before, perhaps even at a later time. Accordingly, there is a need for a seamless solution to facilitate different types of input during a single interaction with the application or across multiple interactions.

To address the above-noted deficiencies, the present techniques provide a multi-modal framework that dynamically switches to different types of input and output interfaces during a single interaction. To enable this, each interaction is started as a mode independent context or thread. The context can identify a self-contained session of interactions in which a multi-modal interface system maintains awareness of the user's inputs, ability levels, preferences, and progress across different types of input modes. In some instances, the context can be saved and accessed later to allow seamless continuation of tasks without requiring the user to restart or reconfigure settings. The user can start or terminate the context at any time. While active, the user can pick up where they left off using any of the supported input and output mechanisms available to them and continue as before.

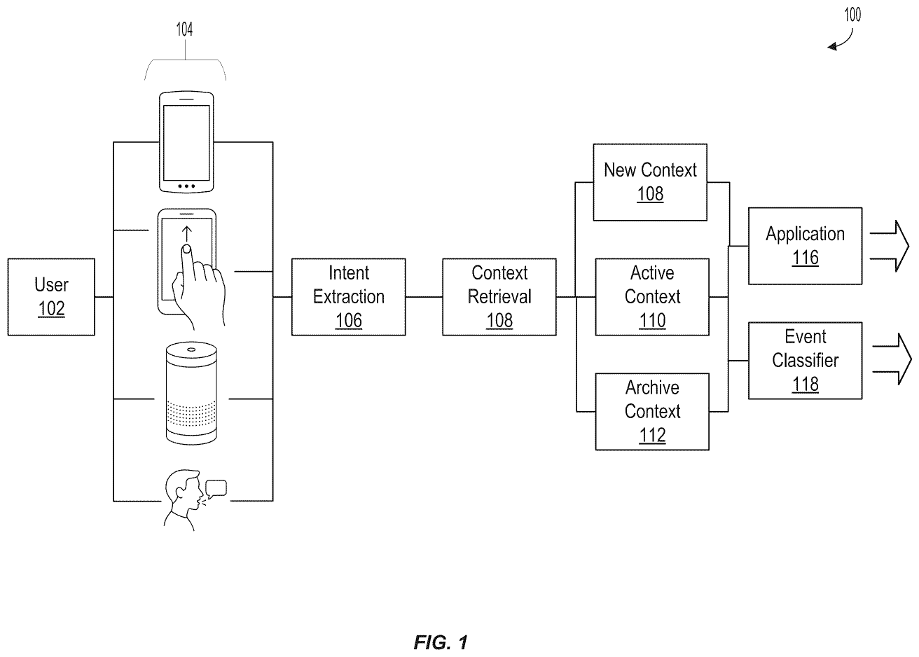

The process works as follows. FIG. 1 illustrates a schematic diagram 100 of implementing multi-modal interaction for people with varying levels of disability, according to some embodiments. A multi-modal interface system can detect that the user 102 is interacting with an application. In some instances, the user can perform a multi-modal interaction 104 with the application using one or more types of user input modes. The types of user input modes can include touch, voice, video, gestures, assistive devices, motion input, biometric input, and brain-computer interface input.

The multi-modal interface system can parse the multi-modal interaction 104 to extract an intent 106. The intent 106 can identify various characteristics associated with the multi-modal interaction 104, including one or more intended inputs across one or more pages of the application as well as expected outputs triggered in response to the intended inputs. In some instances, the extracted intent includes a list of attributes and a verb/command. Attributes can include parameters or properties associated with the multi-modal interaction 104, including user-provided data, measured ability levels (e.g., vision or hearing impairment), contextual metadata, or system-defined variables that refine the intent's meaning and execution. In addition, a verb/command can represent an action or directive associated with the intent, specifying a type of operation the application should perform. The type of operation can include “send,” “select,” “navigate,” or “confirm.”

In some instances, the multi-modal interface system can extract the intent 106 by processing the multi-modal interaction 104 using an intent-discovery machine-learning model. Examples of the intent-discovery machine-learning model (including sub-models of the multimodal model) can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the intent-discovery machine-learning model can include, but are not limited to, genetic algorithms, backpropagation, reinforcement learning, decision trees, linear classification, artificial neural networks, anomaly detection, and such. In yet other examples, the intent-discovery machine-learning model may include regression analysis, dimensionality reduction, metalearning, reinforcement learning, deep learning, and other such algorithms and/or methods.

In some instances, the intent-discovery machine-learning model is a transformer model (e.g., a large-language model (LLM)) obtained from a models database. In some instances, the intent-discovery machine-learning model is trained using self-supervised learning based on a large corpus of text data, such that the intent-discovery machine-learning model can generate narratives. In addition to training the model, various prompts can be used for prompt engineering of the intent-discovery machine-learning model for generating the narratives. Examples of the intent-discovery machine-learning model can include, but are not limited to, BERT model, Claude LLM, Falcon 40B, Ernie, GPT-3, GPT-3.5, GPT 4, Lamda, and Llama.

An illustrative example process of training and deploying the transformer model (e.g., a GPT model) is as follows. For the training dataset (e.g., the previous input data and intent 106), the masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding transformer model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The transformer model can then be trained using autoregressive language modeling to predict a subsequent token of a target sequence based on the contextual representations that represent the preceding tokens. For each position in the sequence, the transformer model accesses a contextual representation of the token, which was generated using masked self-attention mechanism. The transformer model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the transformer model, including the parameters of the Q, K, V matrices.

Through iterative training iterations, the transformer model learns to minimize this loss across the entire training dataset. This process ensures that the model generates coherent and contextually appropriate sequences by leveraging the learned representations and adjusting its parameters based on the training data.

In some instances, the multi-modal interface system can construct one or more prompts that can be submitted with the multi-modal interaction 104 to enhance and increase the accuracy of the intent 106. As used herein, the term “prompt” can refer to an input sequence generated to direct a corresponding machine-learning model's generation process towards producing a target output. In some instances, a filtering prompt includes a sequence of text tokens in a specific format (e.g., text, XML data, JSON data) and language (e.g., English, Korean).

In some instances, the prompts are machine-generated prompts that are generated by one or more computer systems without user intervention. For example, the one or more filtering prompts can be constructed using prompt engineering. Prompt engineering can include techniques for designing and implementing prompts within a machine-learning system to generate target responses or actions. In some instances, prompt engineering leverages a combination of linguistic approaches, machine-learning algorithms, and domain knowledge to formulate prompts that elicit specific outputs from a corresponding machine-learning model. The prompt engineering process typically begins with an analysis of a target or a problem domain, followed by the formulation of prompts tailored to achieve the desired results.

As an illustrative example for optimizing prompts, a prompt P can be defined as a sequence of tokens, tailored to elicit specific responses from a machine-learning model. The model employs an objective function O(P, R) to evaluate the quality of generated responses R given the prompt P. The responses R can be generated based on a machine-learning language model LM processing the prompt P (e.g., the function LM(P)). Different types of objective functions can be selected depending on the task and targeted output. For example, an objective function can correspond to a text summarization technique using ROUGE scores. In another example, the objective function can correspond to a translation quality assessment technique using BLEU scores. In some instances, optimization techniques like gradient descent or evolutionary algorithms are used iteratively refine the prompt P to maximize O(P, R), to facilitate the model to consistently produce accurate, relevant, and contextually appropriate outputs (e.g., the intent 106). For example, the optimal prompt P* can be determine based on maximizing the objective function O:

$$P *= arg max O ( P , LM ( P ) ) \qquad Equation ( 1 )$$

Through the iterative refinement process, prompt engineering enhances the corresponding model's performance across various natural language processing tasks, such as generating the intent 106 that are contextually relevant to the multi-modal interaction 104.

In some instances, prompt engineering includes a selection of input formats and structures. The input-format selection can include determining the syntactic and semantic characteristics of the prompts that will effectively guide the machine-learning model towards the desired outputs. In some instances, linguistics and computational linguistics can be used to select input formats that are semantically meaningful and contextually relevant. The input-format selection can ensure that the prompts effectively communicate the desired tasks or questions to the machine-learning model. The prompt engineering process can also include an optimization of prompt parameters. The optimization can include fine-tuning various parameters such as prompt length, complexity, and specificity to enhance the machine-learning model's performance on targeted tasks. Different prompt formulations and configurations such as grid search or Bayesian optimization can be implemented to optimize the prompt parameters. Additionally or alternatively, techniques such as zero-shot learning or few-shot learning can be implemented to fine-tune the machine-learning models to generalize from limited prompt examples.

The prompt engineering process can be configured based on an underlying machine-learning model architecture and training data. For example, an appropriate pre-trained machine-learning model architecture (e.g., GPT, BERT, or Transformer) that aligns with the task requirements and available computational resources can be identified for a given task. In some instances, the machine-learning model can be fine-tuned on task-specific data to further improve probability of outputting target responses. Various types of training datasets can be used to train and fine-tune the machine-learning model, so as to enable the machine-learning model to understand and generate responses to prompts accurately.

In some instances, an iterative process of designing, testing, and optimizing prompts is implemented based on feedback from initial model outputs. This iterative approach allows for continuous improvement and refinement of the prompt engineering process, ultimately leading to better-performing machine-learning models. Additionally or alternatively, ongoing monitoring and evaluation of model performance can be used to identify any errors or biases introduced by the prompts and prompt engineering process, in which the feedback data can be generated based on the evaluation. The feedback data can be used to further adjust the parameters of the machine-learning models, such that the machine-learning models can be updated to improve accuracy in generating the target responses.

The multi-modal interface system can apply the trained and fine-tuned machine-learning model to the multi-modal interaction 104 to generate the intent 106. To begin the deployment process, the multi-modal interface system can tokenize the merged data into a sequence of text tokens. For example, the merged data can be tokenized to provide the following sequence: [“You”, “are”, “an”, “assistant”, “tasked”, . . . ]. In some instances, the machine-learning model uses Byte Pair Encoding (BPE) techniques to further split a single token (e.g., “in”, “sufficient”).

The multi-modal interface system can assign each token with a particular index value in the vocabulary (e.g., “assistant”=E[5]). Then, the multi-modal interface system can convert each token into a vector representation (e.g., an embedding) based on a pre-trained embedding matrix. For example, for a vocabulary size V and embedding dimension dᵢ, the embedding matrix E is of size V×d, in which the vector eᵢ can be generated for the text token tᵢ based on using the index value looking at a corresponding row of embedding matrix E.

$$E : {e}_{i} = E [ {t}_{i} ] \qquad Equation ( 2 )$$

The multi-modal interface system can then process the sequence of embeddings (e₁, e₂, e₃, . . . eₙ) that represent the sequence of tokens by adding positional encodings to account for the order of tokens. In some instances, positional encodings are vectors added to each token embedding to inject information about the position of tokens in the sequence. A matrix X can be formed that includes the sequence of position-encoded vectors.

For the matrix X, the multi-modal interface system can then determine a contextual representation for each position-encoded vector of the matrix X. In particular, for each position-encoded vector, the multi-modal interface system can generate a set of Q, K, V vectors for the position-encoded vector. As described herein, a Q vector can represent what information the token is querying about other tokens, a K vector can represent the token's context used to establish relationships with other tokens, and a V vector can represent the token's actual content/information.

In some instances, to enhance the model's ability to capture various types of relationships, the position-encoded vector can be represented by multiple sets of Q, K, and V matrices (i.e., multi-head attention). Each set of Q, K, V vectors, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

An attention score can be calculated for the set of Q, K, V vectors as follows:

$$Attention ( Q , K , V ) = soft max ( ( {QK}^{T} ) / √ ( {d}_{k} ) ) V \qquad Equation ( 3 )$$

The (QK^{T})/√(dₖ) can be used to compute the raw attention scores, in which dₖ is the dimensionality of the key vectors. Then, the softmax function is applied to the raw attention score to normalize it into a probability distribution. The multi-modal interface system can apply the attention score to a V vector of the corresponding set of Q, K, V vectors, such that the weighted Q, K, V vectors can be used as the contextual representation of the position-encoded vector of matrix X. In the instances in which multi-head attention is used, the multiple sets of weighted Q, K, V vectors can be concatenated and linearly transformed using a weight matrix W^{O} to generate the contextual representation of the position-encoded vector. The above process can be iterated through other position-encoded vectors of matrix X to generate a set of contextual representations associated with the merged data.

The multi-modal interface system can then apply the machine-learning model to the set of contextual representations to generate the intent 106. In particular, the machine-learning model can process the set of contextual representations to predict each token of the intent 106, in which the output tokens can correspond to the intent 106.

The extracted intent and list of attributes are used to retrieve one or more contexts 108, which includes a lookup of an existing context or thread. The lookup process can include searching for previously stored interactions that match the extracted intent 106 and its attributes, ensuring that the multi-modal interface system can provide continuity in the user experience. Based on the lookup, various outcomes can be determined. As previously described herein, the one or more contexts 108 identify a self-contained session of interactions in which a multi-modal interface system maintains awareness of the user's inputs, ability levels, preferences, and progress across different types of input modes. In some instances, the context can be saved and accessed later to allow seamless continuation of tasks without requiring the user to restart or reconfigure settings. For instance, if a user begins composing an email using keyboard input but pauses midway, the multi-modal interface system can store the session and allow the user to resume later, even if they choose to continue using a different type of interface input (e.g., gestures, voice).

To initiate the lookup, a best-fit is found for an active context 110. Priority will be given to the most recent interaction. For example, the multi-modal interface system can identify a context that is most recent and relevant to the extracted intent 106. Once identified, the multi-modal interface system can resume the interaction using the active context 110, thereby allowing different types of devices (e.g., assistive devices) and interface inputs (e.g., speech instead of text) to be used. As an illustrative example, if a user was last interacting with a smart home assistant to adjust lighting settings, the system will process the intent 106 to check if there is a recent, ongoing session related to that task.

An old conversation thread is retrieved from archived contexts 112. If no active contexts are found, the multi-modal interface system searches archived contexts to locate previous interactions that might still be relevant. For example, if a user in an e-commerce app previously inquired about a product but did not complete the purchase, the multi-modal interface system can retrieve one or more archived conversations from the archived contexts 112 and resume the conversations. This approach allows users to pick up past interactions without starting over, saving time and improving efficiency while also allowing the multi-modal interface system to adjust inputs and outputs based on previously determined ability levels.

If none are found from the archived contexts, a new context 114 is created and tagged with the attributes extracted above. In cases where no relevant active or archived context exists, the multi-modal interface system initiates the new context 114, ensuring that the interaction starts with newly defined parameters. For example, if a user asks a virtual assistant about a topic for the first time, the multi-modal interface system can create the new context 114, associate it with attributes like user ability levels and input mode, and begin processing the request.

The multi-modal interface system can then transmit the contexts (e.g., the new context 114) and the extracted intent 106 to a downstream application. For example the contexts and the extracted intent 106 can be passed to an event classification system 116 or a running application 118. The contexts 108 can thus be used by the application 118 or event classifier 116 to determine subsequent operations.

In some instances, the application 118 may generate an output, such as displaying a text response, generating an audio confirmation, or updating a visual interface based on the extracted intent 106. For example, if the extracted intent 106 indicates a voice assistant to provide information about the weather, the application 118 can retrieve the relevant context 108 and provide a spoken or on-screen response about the weather of a location frequently visited by the user.

In another example, the application 118 may turn on a light if the intent 106 identifies a command through a smart home interface. For example, if a user previously set up the archived context 112 where saying “good night” triggers a series of actions, such as dimming the lights, adjusting the thermostat, and locking the doors, the application 118 can recognize the command and execute the appropriate sequence of operations.

In yet another example, the event classifier 116 may initiate a video call based on the extracted intent 106. For example, if the user has the active context 110 related to an instant messaging session that schedules a meeting during the video call, the event classifier 116 can interpret the extracted intent 106 to initiate “start the call now” and launch the appropriate video conferencing application with the correct participants. The above examples are presented for illustrative purposes only, and other types of downstream application with different types of input modes can be contemplated by a skilled person in the art.

In some instances, the user can further interact with the multi-modal interface system to explicitly stop the thread at any time. For example, if a given user says certain phrases (like, “OK, thanks,” or “That's enough”) or perform certain actions, the context will be marked for archiving. If no other interaction is performed in a given length of time (e.g., inactivity exceeds a time threshold), the context is retired and may not be considered in subsequent searches for recent context.

Additionally or alternatively, if the user wants to revive a retired context, they can ask questions like: “Do you remember when . . . . ” Such phrases or commands can trigger the multi-modal interface system to extract the intent from the question and begin searching for archived or retired contexts to resume the previous interaction. It is noted that the actual mode of the previous interaction is not necessarily maintained and allows seamless switching of different input modes. The context is what is maintained. And, the context allows the user to switch between different modes of interaction without losing their place or being forced into a single mode of operation.

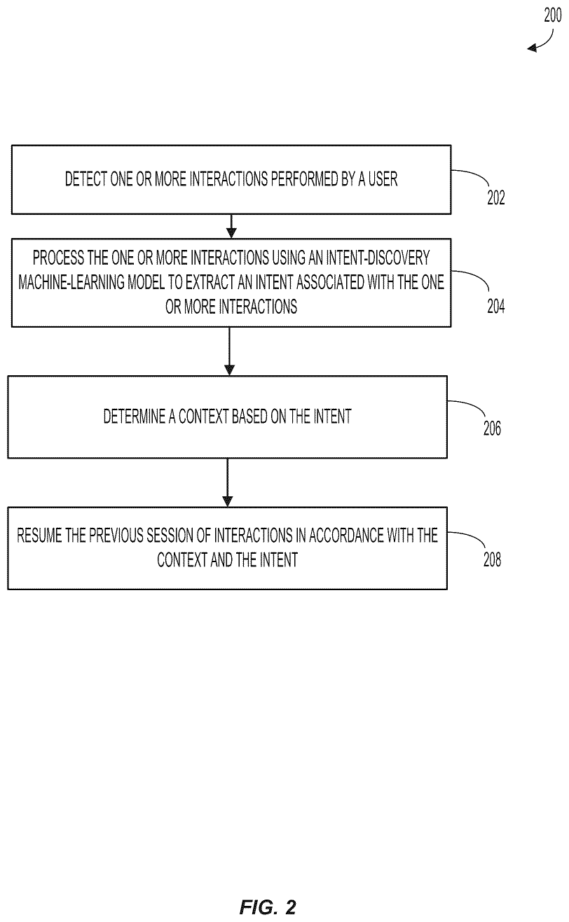

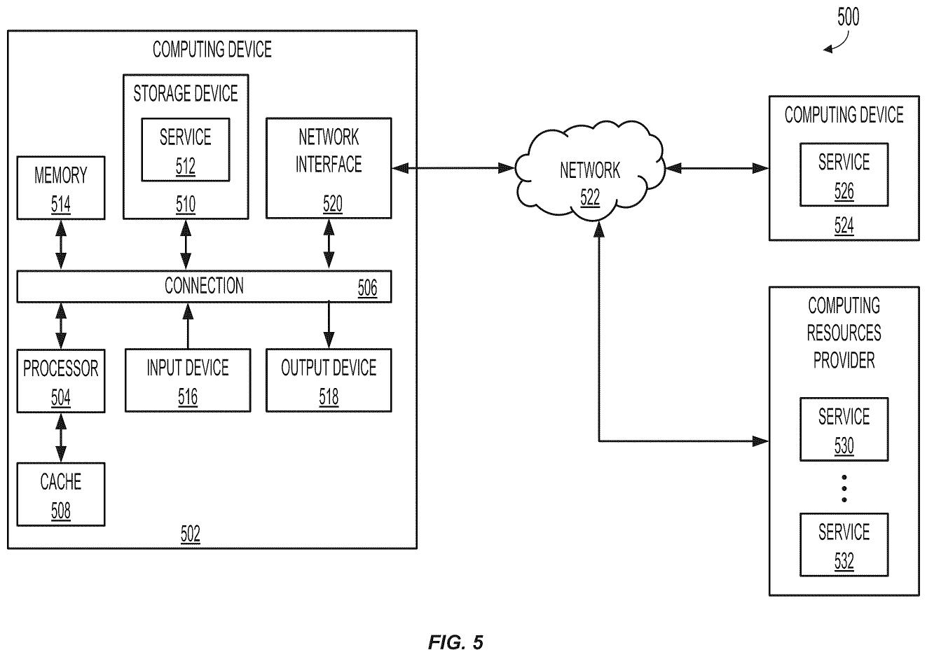

FIG. 2 shows an illustrative example of a process 200 for implementing multi-modal interaction for people with varying levels of disability, in accordance with some embodiments. For illustrative purposes, the process 200 is described with reference to the components illustrated in FIG. 1, though other implementations are possible. For example, the program code for the multi-modal interface system of FIG. 1, is executed by one or more processing devices to cause a server system (e.g., the computing device 502 of FIG. 5) to perform one or more operations described herein.

At step 202, the multi-modal interface system detects one or more interactions performed by a user. Examples of the one or more interactions can include, but are not limited to, a click interaction, a swipe gesture, a drag and drop operation, and a voice command. In some instances, the one or more interactions are associated with a particular application. The one or more interactions can be performed using a first input mode (e.g., text input). Different types of input modes can include voice input, text input, touch input, gesture input, assistive devices, motion input, biometric input, and brain-computer interface input.

At step 204, the multi-modal interface system processes the one or more interactions using an intent-discovery machine-learning model to extract an intent associated with the one or more interactions. The intent can identify one or more intended inputs for the application and an expected output to be triggered in response to the one or more intended inputs. In some instances, the extracted intent includes a list of attributes and a verb/command. Attributes can include parameters or properties associated with the one or more interactions, including user-provided data, measured ability levels (e.g., vision or hearing impairment), contextual metadata, or system-defined variables that refine the intent's meaning and execution. In addition, a verb/command can represent an action or directive associated with the intent, specifying a type of operation the application should perform. The type of operation can include “send,” “select,” “navigate,” or “confirm.”

In some instances, the multi-modal interface system can extract the intent by processing the one or more interactions using an intent-discovery machine-learning model. Examples of the intent-discovery machine-learning model (including sub-models of the multimodal model) can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the intent-discovery machine-learning model can include, but are not limited to, genetic algorithms, backpropagation, reinforcement learning, decision trees, linear classification, artificial neural networks, anomaly detection, and such. In yet other examples, the intent-discovery machine-learning model may include regression analysis, dimensionality reduction, metalearning, reinforcement learning, deep learning, and other such algorithms and/or methods.

In some instances, the intent-discovery machine-learning model is a transformer model (e.g., a large-language model (LLM)) obtained from a models database. In some instances, the intent-discovery machine-learning model is trained using self-supervised learning based on a large corpus of text data, such that the intent-discovery machine-learning model can generate narratives. In addition to training the model, various prompts can be used for prompt engineering of the intent-discovery machine-learning model for generating the narratives. Examples of the intent-discovery machine-learning model can include, but are not limited to, BERT model, Claude LLM, Falcon 40B, Ernie, GPT-3, GPT-3.5, GPT 4, Lamda, and Llama.

At step 206, the multi-modal interface system determines a context based on the intent. The context can identify a previous session of interactions that store previously used input modes, user ability data, and interaction progress associated with the previous session. In some instances, the previous session is associated with the particular application.

The multi-modal interface system can determine the context by performing a query on a context database to retrieve an active context or an archived context. In some instances, the query is generated based on the intent. The active context can indicate that the previous session is an active communication session. The archived context can indicate that the previous session is an inactive communication session. For example, if a user previously set up the archived context where saying “good night” triggers a series of actions, such as dimming the lights, adjusting the thermostat, and locking the doors, the particular application can recognize the command and execute the appropriate sequence of operations.

At step 208, the multi-modal interface system resumes the previous session of interactions in accordance with the context and the intent. In some instances, resuming the previous session of interactions includes using a second input mode (e.g., voice input) to perform subsequent interactions. In some instances, if the one or more interactions are detected at a first device, the multi-modal interface system can resume the previous session at a second device that is different from the first device. Process 200 terminates thereafter.

### B. Cloud-Based Mechanism for Access and Storage of User Disability Data

As previously described, we can build a profile of a user's abilities, and interact with them in whatever method best matches their abilities. This could be stored inside a single device or on a shared gateway. But what happens when a user moves away from that location, or is in-transit from one location to another? For example, an elderly person may have their home environment set up exactly as needed. But they may end up in a doctor's office, remain hospitalized after an operation, or visit their children. That environment would no longer be available to them, making leaving their home-base a fraught and potentially anxiety-inducing action.

To address the aforementioned challenges, the present techniques allow compatible systems associated with the user to securely access the collection of usability data and profiles from any location and allow the user to continue their interactions without losing privacy or confidentiality.

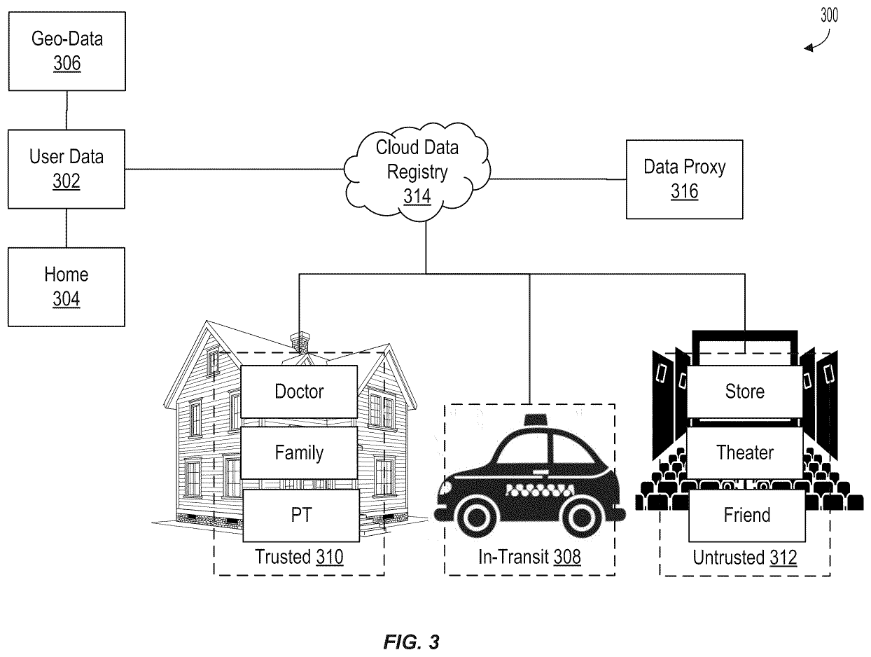

FIG. 3 illustrates a schematic diagram 300 for access and storage of user disability data across various geographic locations, according to some embodiments. Initially, a single source of truth for obtaining user ability data 302 can be determined. For example, the user ability data 302 can store any type of user data that identifies one or more characteristics associated with ability degradation of a corresponding user. For example, the user ability data 302 can include a name, an address, age, and gender of the user. In some instances, the user ability data 302 can determine estimated level of ability degradation and rates of degradation change over a time course, either of which can be determined based on active learning of computing operations (e.g., inputs, failure to respond to certain pages) performed by the user across various applications. The active learning facilitates the user ability data 302 to be dynamically updated in real-time.

For example, if the user frequently enters wrong text information into the application, the user ability data 302 can indicate that user may be associated with a motor impairment. In some instances, user settings of the user ability data 302 can also indicate certain impairments or disabilities associated with the user. For example, if the user settings indicate the font and content to be displayed larger on the screen, the user ability data 302 can indicate a possible vision impairment of the user.

In some instances, user ability data is stored in at a primary location 304 (e.g., home). The primary location 304 can be a physical place, such as a home, office, or designated workspace, in which primary devices and networks are used for data access. The primary location 304 can also indicate a specific device (e.g., a gateway device) that serves as the main hub for accessing and storing data. In some cases, a secured network environment, such as a VPN, corporate intranet, or home Wi-Fi network, can act as the main gateway for accessing the user ability data 302 from the primary location 304.

In some instances, the user ability data 302 can be locally stored in a secure device located in the primary location 304, such as a home gateway device. The user ability data 302 can be privately and securely accessed by all devices throughout the primary location 304. Further, to further protect the user ability data 302, geolocation data 306 of one or more devices can be tracked such that an attempt to access the user ability data 302 at an unauthorized location can be blocked from access.

When a user leaves the primary location 304, the user ability data 302 can remains at the primary location 304. In some instances, the user ability data 302 can be configured to be accessed securely while the user is moving to another location. Such configuration allows the user to continue using one or more device or interface functions that are customized based on the user ability data 302 thereby increasing accessibility of certain applications and devices.

For example, the user ability data 302 can form a “bundle” or “package” and be marked to indicate any destination or routes at which user ability data 302 can be accessed. For example, the user ability data 302 can be indicated by the user as being static or in-transit 308, at known and trusted locations 310 (e.g., home, doctor, family home), or at unknown and untrusted locations 312 (e.g., supermarket, visiting friend, park). In some instances, the geolocation data 306 associated with the user ability data 302 can be continuously tracked so it can be automatically transferred to the trusted location 310 when the user has left their home and is carrying a mobile phone with the appropriate software installed.

When the user travels to a new destination where the information needs to be accessed for subsequent interactions, there are different ways to access the user ability data 302. For example, when the user has indicated that he or she will be traveling from one location to another, the cloud data registry 314 is notified and the user-ability data 302 is placed in an in-transit state 308 (“IN-TRANSIT”). This means any interaction with the data will have to go through the cloud data registry 314 in order to locate the exact location of the data.

While in-transit, the user ability data 302 can be accessed remotely via secure tunneling back to the gateway device at the primary location 304. Secure tunneling is a method of transmitting data through an encrypted connection that protects it from unauthorized access while traveling across networks. It works by encapsulating the data within a secure communication protocol, such as a VPN (Virtual Private Network) or SSH (Secure Shell), ensuring that the transmitted information remains private and tamper-proof. By creating a direct and encrypted link between the remote user and the gateway device at the primary location, secure tunneling prevents interception and maintains data integrity. In some instances, secure tunneling may be performed only with destinations that have been approved for remote access. In this case the data is kept on the gateway at home and the single source of truth is maintained.

Different techniques can be implemented to assist in protecting the user ability data stored at the primary location 304. For example, the techniques can include encryption, firewalls, and multi-factor authentication. Encryption ensures that any data transmitted over a network is converted into a secure format that can only be deciphered by authorized parties. This can be applied to both data at rest (stored data) and data in transit (data being transmitted). Firewalls act as barriers between a private network and the internet, filtering incoming and outgoing traffic to block unauthorized access. By configuring firewalls at the gateway device, users can control which devices and services can access their home network. Additionally, multi-factor authentication adds an extra layer of security by requiring users to verify their identity through multiple methods, such as a password and a fingerprint or a security token, before accessing the sensitive data (e.g., the user ability data). These techniques, when used together, enhance the overall protection of user ability data 302 when accessing it during transit. The above techniques are presented for illustrative purposes only, and other types of data protection techniques can be contemplated by a person skilled in the art.

In some instances, the user ability data 302 can be uploaded from the gateway at the primary location 304 to a cloud data registry 314. The user can thus access the user ability data 302 from the cloud data registry 314 while in transit. In some instances, the user ability data 302 can be encrypted and compressed to further secure the user ability data 302 that has been copied out from the primary location 304. The geo-location 306 of the user ability data 302 is registered with the cloud data registry 314 so remote software requiring access of the user ability data 302 can obtain the latest location for access.

Additionally or alternatively, custody of the user ability data 302 can be migrated to the alternate location (e.g., another server, cloud storage, backup system), in which a data proxy 316 such as a different entity or system takes over the storage and management of the user ability data 302. Additionally or alternatively, the user ability data 302 can be loaded to a physical transport mechanism such as a phone or thumb-drive, which allows the user to locally access the user ability data 302 at a different destination or while in-transit to the different destination.

In the event the user ability data 302 is copied out to the other location, the user ability data 302 can be marked as immutable on the gateway device. This would prevent the user ability data 302 from being inadvertently modified or updated from different destinations. In some instances, the custody of the user ability data 302 can be transferred up to a new location temporarily, while the user is present at that location. For example, the user can be temporarily hospitalized in a medical care center. In this case, custody of the data has changed from the primary location 304 to the new location (e.g., the medical care center). As a result of the transfer, the copy at the remote location becomes the one source of truth. The user ability data 302 may then be updated and changed while the user is present at the location. Continuing with the example, the user can modify the user ability data 302 while being hospitalized at the new location, such that certain application functions can be adapted to changes in the user abilities captured in the new location (e.g., the user has slurred speech due to anesthesia thus eliminating the voice recognition feature).

When time comes to return to the primary location 304, the user ability data 304 is once again marked as frozen, compressed and encrypted, and uploaded into the cloud data registry 314 or copied back onto a transportation storage device. The sequence is reversed when the user returns to the primary location 304, such that the newly updated user ability data is transferred back to the home gateway device. For example, when the user returns to the primary location 304, the user ability data 302 will be placed in a HOME state, allowing interaction only with the single source of truth at home (e.g., the gateway device) instead of the cloud registry. This is different from other states (e.g., IN-TRANSIT), in which the user ability data 302 will be copied to a cloud proxy where access will be regulated whether the source is trusted or not.

In some instances, when the user returns from the untrusted location 312 (“UNTRUSTED”) back to the primary location 304 (“HOME”), the user ability data 302 is run through a verification system to make sure none of the data is corrupted or missing. Examples of a verification system for checking data corruption include checksum algorithms, such as MD5 or SHA, which calculate a unique hash value based on the content of the data. If the data is modified or corrupted, the hash value will change, allowing the system to detect discrepancies. Another example is using cyclic redundancy checks (CRC), which are designed to detect accidental changes to raw data during transmission or storage. These verification systems ensure that data integrity is maintained and can alert administrators if any corruption is detected. If returning from the trusted location 310 (“TRUSTED”), a lighter form of verification can be performed. A lighter form of verification can include simplified or less resource-intensive checks that can be used when the source of the data is considered secure or trusted. For example, the system might perform a basic comparison to ensure the data structure matches expected formats, or it could check for basic integrity indicators like file size or timestamp consistency. Unlike more thorough verification methods that check the entire data content, a lighter verification might focus only on high-level checks that are sufficient when returning data from a trusted location.

The secure transfer is not only limited to the user ability data 302, but can include other types of user data including user preferences, snapshot of health data, or device telemetry. These transfer of the user ability 302 can occur as one or more background processing, other than the user indicating departure of the primary location 304, arriving at the destination, and vice versa. In some instances, the user can be authenticated during each stage using non-intrusive multi-factor authentication.

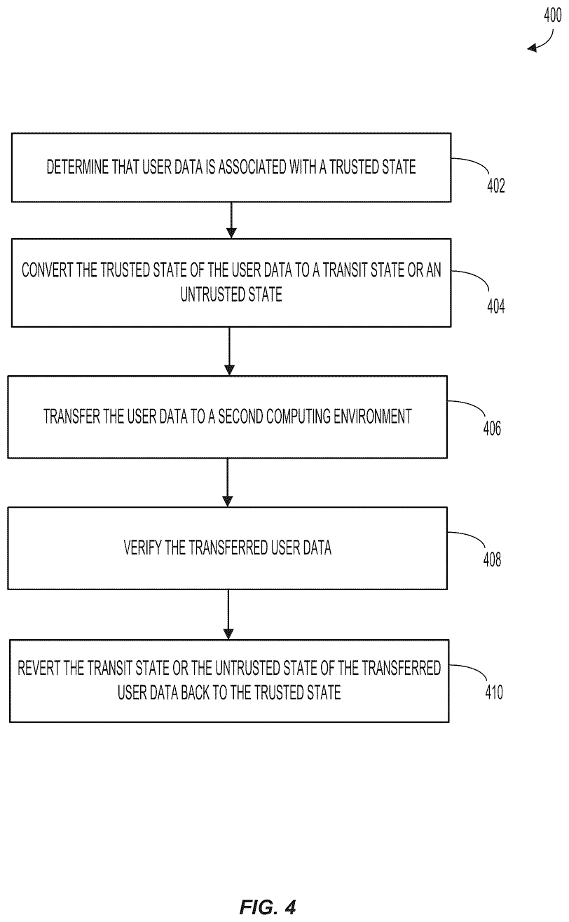

FIG. 4 shows an illustrative example of a process 400 for access and storage of user disability data across various geographic locations, in accordance with some embodiments. For illustrative purposes, the process 400 is described with reference to the components illustrated in FIG. 3, though other implementations are possible. For example, the program code for a data-transfer application, is executed by one or more processing devices to cause a server system (e.g., the computing device 502 of FIG. 5) to perform one or more operations described herein.

At step 402, the data-transfer application determines that user data is associated with a trusted state. In some instances, the user data includes user ability data that identifies one or more characteristics associated with ability degradation of a corresponding user. In some instances, the user ability data can identify an estimated level of ability degradation and rates of degradation change over a time course, either of which can be determined based on active learning of computing operations (e.g., inputs, failure to respond to certain pages) performed by the user across various applications. The active learning facilitates the user ability data to be dynamically updated in real-time.

In some instances, the user data is stored at a primary location associated with a user. The primary location can be a designated physical place, such as a home, office, or designated workspace, in which primary devices and networks are used for data access. The primary location can also indicate a gateway device that serves as the main hub for accessing and storing the user data. In some cases, a secured computing environment, such as a VPN, corporate intranet, or home Wi-Fi network, can act as the main gateway for accessing the user ability data from the primary location.

The user data can be privately and securely accessed by all devices throughout the primary location. Further, to further protect the user data, geolocation data of one or more devices can be tracked such that an attempt to access the user data at an unauthorized location can be blocked from access.

At step 404, the data-transfer application converts the trusted state of the user data to a transit state or an untrusted state. For example, the user data can be stored as a “bundle” or “package” and be marked to indicate any destination or routes at which user data can be accessed. The transit state can indicate that the user is relocating to another destination. The untrusted state can indicate the user is located at a network environment (e.g., supermarket, visiting friend, park) that is unknown or unverified by the data-transfer application. In some instances, the geolocation data associated with the user data can be continuously tracked so it can be automatically transferred to the trusted location when the user has left the primary location

At step 406, the data-transfer application transfers the user data to a second computing environment. The second computing environment is associated with another location different from the primary location associated with the user. In the event the user data is transferred to the second location, the user data can be marked as immutable on the gateway device. This would prevent the user data from being inadvertently modified or updated from different destinations.

The second computing environment can include a cloud data registry. In some instances, the user data can be uploaded from the gateway at the primary location to the cloud data registry. The user can thus access the user data from the cloud data registry while under the transit state. In some instances, the user data can be encrypted and compressed to further secure the user data that has been copied out from the primary location. The geo-location of the user data can be registered with the cloud data registry, such that remote software requiring access of the user data can obtain the latest location for access.

Additionally or alternatively, the user data can be loaded to a physical transport mechanism such as a phone or thumb-drive (i.e., another example of the second computing environment), which allows the user to locally access the user data at a different destination or while in-transit to the different destination.

At step 408, the data-transfer application verifies the transferred user data. Examples of a verification system for checking data corruption can include but are not limited to checksum algorithms, such as MD5 or SHA, which calculate a unique hash value based on the content of the data. If the data is modified or corrupted, the hash value will change, allowing the system to detect discrepancies. Another example is using cyclic redundancy checks (CRC), which are designed to detect accidental changes to raw data during transmission or storage. These verification systems ensure that data integrity is maintained and can alert administrators if any corruption is detected.

At step 410, the data-transfer application reverts the transit state or the untrusted state of the transferred user data back to the trusted state. In some instances, the data-transfer application can additionally transfer custody of the transferred data to the second computing environment. For example, custody of the user data can be migrated to the alternate location (e.g., another server, cloud storage, backup system), in which a data proxy associated with the second computing environment can take over the storage and management of the user data. Process 400 terminates thereafter.

### II. Example Systems

FIG. 5 illustrates a computing system architecture 500, including various components in electrical communication with each other, in accordance with some embodiments. The example computing system architecture 500 illustrated in FIG. 5 includes a computing device 502, which has various components in electrical communication with each other using a connection 506, such as a bus, in accordance with some implementations. The example computing system architecture 500 includes a processing unit 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system architecture 500 includes a cache 508 of high-speed memory connected directly with, in close proximity to, or integrated as part of the processor 504. The system architecture 500 can copy data from the memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The memory 514 may be referred to herein as system memory or computer system memory. The memory 514 may include, at various times, elements of an operating system, one or more applications, data associated with the operating system or the one or more applications, or other such data associated with the computing device 502.

Other system memory 514 can be available for use as well. The memory 514 can include multiple different types of memory with different performance characteristics. The processor 504 can include any general purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 500, an input device 516 can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the attached input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system architecture 500, the storage device 510 can be connected to other parts of the computing device 502 using the system connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, memory 514, input device 516, output device 518, and so forth, can carry out the functions such as those described herein.

The disclosed systems and service of a multi-modal interface system (e.g., the multi-modal interface system described herein at least in connection with FIG. 1) can be performed using a computing system such as the example computing system illustrated in FIG. 5, using one or more components of the example computing system architecture 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems associated with the multi-modal interface system described herein by, for example, executing code using a processor such as processor 504 wherein the code is stored in memory such as memory 514 as described herein. One or more of a user device, a provider server or system, a database system, or other such devices, services, or systems may include some or all of the components of the computing system such as the example computing system illustrated in FIG. 5, using one or more components of the example computing system architecture 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, or other such microprocessors. In some embodiments, the processor 504 can include multiple elements such as a core, one or more registers, and one or more processing units such as arithmetic logic units (ALU), floating point units (FPU), graphics processing units (GPU), physics processing units (PPU), neural processing units (NPU), tensor processing units (TPU), digital system processing (DSP) units, or combinations of these and/or other such processing units. The processor 804 can be implemented through different processor architectures, such as Reduced Instruction Set Computing (RISC) architectures (e.g., RISC-V, etc.), Advanced RISC Machine (ARM) architectures, and the like. One of skill in the relevant art will recognize that the terms “machine-readable (storage) medium” or “computer-readable (storage) medium” include any type of device that is accessible by the processor.

The memory 514 can be coupled to the processor 504 by, for example, a connector such as connector 506, or a bus. As used herein, a connector or bus such as connector 506 is a communications system that transfers data between components within the computing device 502 and may, in some embodiments, be used to transfer data between computing devices. The connector 506 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 514 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 514 can also include magnetic or optical data storage media including read-only (e.g., CD ROM and DVD ROM) or otherwise (e.g., CD or DVD). The memory can be local, remote, or distributed.

As described above, the connector 506 (or bus) can also couple the processor 504 to the storage device 510, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, Android/AOSP, etc.), embedded systems such as FreeRTOS, Zephyr, and Arduino, and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services 526 to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as memory 514, an input device such as input device 516, and an output device such as output device 518. In such embodiments, the computing device 524 can carry out the functions such as those described herein in connection with computing device 502. In some embodiments, the computing device 502 can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), RPC, Matter, CANBus, and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), Protobuf, MsgPack, BSON, and other such protocols and/or structured languages. The information may first be processed by the computing device 502 and presented to a user of the computing device 502 using forms that are perceptible via sight, sound, smell, taste, touch, or other such mechanisms. In some embodiments, communications over the network 522 can be received and/or processed by a computing device configured as a server. Such communications can be sent and received using PHP: Hypertext Preprocessor (“PHP”), Python™, Ruby, Perl® and variants, Java®, HTML, C, C++, Lua, Swift, Kotlin, XML, or another such server-side processing language.

In some embodiments, the computing device 502 and/or the computing device 524 can be connected to a computing resources provider 528 via the network 522 using a network interface such as those described herein (e.g. network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the service 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 200 of FIG. 2). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 502.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
detecting one or more interactions performed by a user, wherein the one or more interactions are associated with a particular application, and wherein the one or more interactions are performed using a first input mode;
processing the one or more interactions using an intent-discovery machine-learning model to extract an intent associated with the one or more interactions, wherein the intent identifies one or more intended inputs for the application and an expected output to be triggered in response to the one or more intended inputs;
determining a context based on the intent, wherein the context identifies a previous session of interactions that store previously used input modes, user ability data, and interaction progress associated with the previous session, and wherein the previous session is associated with the particular application; and
resuming the previous session of interactions in accordance with the context and the intent, wherein resuming the previous session of interactions includes using a second input mode to perform subsequent interactions, and wherein the second input mode is different from the first input mode.

2. The computer-implemented method of claim 1, wherein the intent-discovery machine-learning model includes a transformer model.

3. The computer-implemented method of claim 1, wherein the first input mode includes text input and the second input mode includes voice input.

4. The computer-implemented method of claim 1, wherein the one or more intended inputs specify a type of operation or command to be executed by the particular application.

5. The computer-implemented method of claim 1, wherein determining the context includes performing a query on a context database to retrieve an active context, wherein the query is generated based on the intent, and wherein the active context indicates that the previous session is an active communication session.

6. The computer-implemented method of claim 1, wherein determining the context includes performing a query on a context database to retrieve an archived context, wherein the query is generated based on the intent, and wherein the archived context indicates that the previous session is an inactive communication session.

7. The computer-implemented method of claim 1, wherein the one or more interactions are detected at a first device, and wherein resuming the previous session of interactions includes resuming the previous session at a second device that is different from the first device.

8. A system comprising:
one or more processors; and
memory storing thereon instructions that, as a result of being executed by the one or more processors, cause the system to perform operations comprising:
detecting one or more interactions performed by a user, wherein the one or more interactions are associated with a particular application, and wherein the one or more interactions are performed using a first input mode;
processing the one or more interactions using an intent-discovery machine-learning model to extract an intent associated with the one or more interactions, wherein the intent identifies one or more intended inputs for the application and an expected output to be triggered in response to the one or more intended inputs;
determining a context based on the intent, wherein the context identifies a previous session of interactions that store previously used input modes, user ability data, and interaction progress associated with the previous session, and wherein the previous session is associated with the particular application; and
resuming the previous session of interactions in accordance with the context and the intent, wherein resuming the previous session of interactions includes using a second input mode to perform subsequent interactions, and wherein the second input mode is different from the first input mode.

9. The system of claim 1, wherein the intent-discovery machine-learning model includes a transformer model.

10. The system of claim 1, wherein the first input mode includes text input and the second input mode includes voice input.

11. The system of claim 1, wherein the one or more intended inputs specify a type of operation or command to be executed by the particular application.

12. The system of claim 1, wherein determining the context includes performing a query on a context database to retrieve an active context, wherein the query is generated based on the intent, and wherein the active context indicates that the previous session is an active communication session.

13. The system of claim 1, wherein determining the context includes performing a query on a context database to retrieve an archived context, wherein the query is generated based on the intent, and wherein the archived context indicates that the previous session is an inactive communication session.

14. The system of claim 1, wherein the one or more interactions are detected at a first device, and wherein resuming the previous session of interactions includes resuming the previous session at a second device that is different from the first device.

15. A non-transitory, computer-readable storage medium storing thereon executable instructions that, as a result of being executed by one or more processors of a computer system, cause the computer system to perform operations comprising:
detecting one or more interactions performed by a user, wherein the one or more interactions are associated with a particular application, and wherein the one or more interactions are performed using a first input mode;
processing the one or more interactions using an intent-discovery machine-learning model to extract an intent associated with the one or more interactions, wherein the intent identifies one or more intended inputs for the application and an expected output to be triggered in response to the one or more intended inputs;
determining a context based on the intent, wherein the context identifies a previous session of interactions that store previously used input modes, user ability data, and interaction progress associated with the previous session, and wherein the previous session is associated with the particular application; and
resuming the previous session of interactions in accordance with the context and the intent, wherein resuming the previous session of interactions includes using a second input mode to perform subsequent interactions, and wherein the second input mode is different from the first input mode.

16. The non-transitory, computer-readable storage medium of claim 15, wherein the intent-discovery machine-learning model includes a transformer model.

17. The non-transitory, computer-readable storage medium of claim 15, wherein the first input mode includes text input and the second input mode includes voice input.

18. The non-transitory, computer-readable storage medium of claim 15, wherein the one or more intended inputs specify a type of operation or command to be executed by the particular application.

19. The non-transitory, computer-readable storage medium of claim 15, wherein determining the context includes performing a query on a context database to retrieve an active context, wherein the query is generated based on the intent, and wherein the active context indicates that the previous session is an active communication session.

20. The non-transitory, computer-readable storage medium of claim 15, wherein determining the context includes performing a query on a context database to retrieve an archived context, wherein the query is generated based on the intent, and wherein the archived context indicates that the previous session is an inactive communication session.

21. The non-transitory, computer-readable storage medium of claim 15, wherein the one or more interactions are detected at a first device, and wherein resuming the previous session of interactions includes resuming the previous session at a second device that is different from the first device.
